(19) United States
(12) Patent Application Publication
(10) Pub. No.: US 2026/0313510 A1
(43) Pub. Date: Oct. 8, 2026

(54) TIMER BASED HANDOVER IN A NETWORK ENERGY SAVING CELL

(71) Applicant: LENOVO (SINGAPORE) PTE. LTD., Singapore (SG)

(72) Inventors: Prateek Basu Mallick, Dreieich (DE); Joachim Löhr, Wiesbaden (DE); Shwetha Sreejith, Steinbach (DE)

(73) Assignee: LENOVO (SINGAPORE) PTE. LTD., Singapoure (SG)

(21) Appl. No.: 19/482,618

(22) PCT Filed: May 8, 2024
(86) PCT No.: PCT/IB2024/054458

§ 371 Date: Nov. 7, 2025

Related U.S. Application Data
(60) Provisional application No. 63/464,925, filed on May 8, 2023.

(51) Int. Cl. H04W 36/36; H04W 36/00; H04W 74/0833; H04W 76/20

(52) U.S. Cl. CPC H04W 36/362; H04W 36/0058; H04W 74/0833; H04W 76/20

(57) ABSTRACT

Various aspects of the present disclosure relate to timer based handover in a network energy saving cell. A UE receives, from a network entity (e.g., a gNB) a signaling (e.g., radio resource control (RRC) Connection Reconfiguration message) indicating a conditional handover configuration that includes one or more handover conditions. The UE starts a timer in response to determining that the one or more handover conditions for a candidate cell are fulfilled. The UE executes the handover to the candidate cell in response to receiving a lower layer signaling (e.g., a layer 1 signaling) from the network entity before expiry of the timer. If the timer expires but the handover is not executed, the UE resumes measuring and evaluating handover conditions for candidate cells rather than executing the handover.

### RELATED APPLICATION

This application claims priority to U.S. Patent Application Ser. No. 63/464,925 filed May 8, 2023 entitled “TIMER BASED HANDOVER IN A NETWORK ENERGY SAVING CELL,” the disclosure of which is incorporated by reference herein in its entirety.

### TECHNICAL FIELD

The present disclosure relates to wireless communications, and more specifically to timer based handover in a network energy saving cell.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system includes numerous devices that consume power. Various different techniques may be used by the different devices in the wireless communications system in order to reduce power usage in the wireless communications system.

### SUMMARY

The present disclosure relates to methods, apparatuses, and systems that support timer based handover in a network energy saving cell. A UE receives, from a network entity (e.g., a gNB) a signaling (e.g., radio resource control (RRC) Connection Reconfiguration message) indicating a conditional handover configuration that includes one or more handover conditions. The UE starts a timer in response to determining that the one or more handover conditions for a candidate cell are fulfilled. The UE executes the handover to the candidate cell in response to receiving a lower layer signaling (e.g., a layer 1 signaling) from the network entity before expiry of the timer. If the timer expires but the handover is not executed, the UE resumes measuring and evaluating handover conditions for candidate cells rather than executing the handover. By not executing the handover if the timer expires, the situation of handing over to a candidate cell for which the one or more handover conditions are no longer fulfilled is avoided.

Some implementations of the method and apparatuses described herein may further include to: receive, from a network entity, a first signaling indicating a conditional handover configuration that includes one or more handover conditions; start a timer in response to determining that one or more handover conditions for a candidate cell indicated in the first signaling are fulfilled; and execute handover to the candidate cell in response to receiving a lower layer signaling from the network before expiry of the timer.

In some implementations of the method and apparatuses described herein, the first signaling comprises a RRC Connection Reconfiguration message. Additionally or alternatively, the first signaling indicates a timer value for the timer. Additionally or alternatively, the method and apparatus may restart measuring and evaluating handover conditions for the candidate cell upon expiry of the timer. Additionally or alternatively, the RRC Connection Reconfiguration message includes RRC Reconfiguration for one or more candidate cells. Additionally or alternatively, the one or more handover conditions include measurement events and may be based on at least one of radio condition evaluation, time condition evaluation, or location condition evaluation. Additionally or alternatively, the candidate cell becomes a target cell in response to determining that the one or more handover conditions for the candidate cell are fulfilled. Additionally or alternatively, to execute handover to the candidate cell includes tuning to a frequency of the candidate cell, synchronizing to a downlink channel of the candidate cell, and initiating a random access channel (RACH) procedure to announce arrival of the apparatus at the candidate cell. Additionally or alternatively, the apparatus comprises a UE.

Some implementations of the method and apparatuses described herein may further include to: transmit, to a UE, a first signaling indicating a conditional handover configuration that includes one or more handover conditions including a timer value for a timer, the timer value indicating an amount of time the UE is to wait to receive a lower layer signaling for a candidate cell for which the one or more handover conditions are fulfilled; and transmit, to the UE, the lower layer signaling.

In some implementations of the method and apparatuses described herein, wherein the lower layer signaling indicates a start of sleep time of a cell served by the apparatus. Additionally or alternatively, wherein the first signaling comprises a RRC Connection Reconfiguration message.

Additionally or alternatively, the RRC Connection Reconfiguration message includes RRC Reconfiguration for one or more candidate cells. Additionally or alternatively, the one or more handover conditions include measurement events and may be based on at least one of radio condition evaluation, time condition evaluation, or location condition evaluation.

### BRIEF DESCRIPTION OF THE DRAWINGS

FIG. 1 illustrates an example of a wireless communications system that supports timer based handover in a network energy saving cell in accordance with aspects of the present disclosure.

FIG. 2 illustrates an example of two RRC Connected UEs with their corresponding discontinuous reception (DRX) configurations that supports timer based handover in a network energy saving cell in accordance with aspects of the present disclosure.

FIG. 3 illustrates an example 300 of two RRC Connected UEs with their corresponding DRX configurations that supports timer based handover in a network energy saving cell in accordance with aspects of the present disclosure.

FIG. 4 illustrates an example of handover being executed that supports timer based handover in a network energy saving cell in accordance with aspects of the present disclosure.

FIGS. 5 and 6 illustrate examples of block diagrams of devices that support timer based handover in a network energy saving cell in accordance with aspects of the present disclosure.

FIGS. 7 through 12 illustrate flowcharts of methods that support timer based handover in a network energy saving cell in accordance with aspects of the present disclosure.

### DETAILED DESCRIPTION

A source cell (also referred to as a serving cell) sends a conditional handover configuration (e.g., a RRCReconfiguration message containing conditionalReconfiguration), also referred to as “CHO” herein, to a UE but starts a NES technique only some time later, allowing the UEs in the cell sufficient time to evaluate handover conditions contained in the CHO. Due to this, there might a time lag between the fulfillment of handover conditions towards a candidate cell and the time when the source cell starts the NES technique, e.g., starts to sleep (transitions to non-active time). A too early handover execution will lead to the UE breaking connection from an otherwise very strong source cell and going to a relaxed-radio-conditioned target cell. A too late handover execution may mean that the conditions once considered fulfilled by the target cell are not valid anymore. Both of these situations lead to a bad user experience.

Generally, the UE evaluates using a configured timer how long the one or more handover conditions met for a candidate cell can be considered valid. Additionally or alternatively, the UE starts measurement or evaluation just in time before the source cell actually starts to sleep.

In one or more implementations, the conditional handover procedure is used including multiple candidate cells with their one or more handover conditions, which may be specific for the case when NES mode is configured by the source cell. A UE starts the condition evaluation when the source cell indicates using a lower layer (e.g., layer 1) signaling that the source cell is switching to sleep state at a specific time in the future, allowing the UE to still have sufficient time for measurement or condition evaluation. If the one or more NES radio conditions are fulfilled for one of the candidate cells, the UE executes handover; otherwise, the UE informs the source cell that no suitable target (no candidate fulfills the conditions) could be found.

The UE receives, from a network entity (e.g., a gNB) a signaling (e.g., a RRC Connection Reconfiguration message) indicating a conditional handover configuration that includes one or more handover conditions. The UE starts a timer in response to determining that the one or more handover conditions for a candidate cell are fulfilled. The UE executes the handover to the candidate cell in response to receiving a lower layer signaling (e.g., a layer 1 signaling) from the network entity before expiry of the timer. If the timer expires but the handover is not executed, the UE resumes measuring and evaluating handover conditions for candidate cells rather than executing the handover.

One solution to handle the conditional handover procedure is to carry on with the mobility procedure as in legacy, e.g., using purely the radio condition of the source and one or more candidate cells. This could lead to the UE not being handed over to any cell since the one or more legacy radio conditions may not be satisified at a time when the source cell had intended to switch to sleep or switch off, in turn either leading the source cell to continue to remain awake and serve the UE or just start sleeping or conserving energy and leaving the UE with no service. By not executing the handover if the timer expires, the situation of handing over to a candidate cell for which the one or more handover conditions are no longer fulfilled is avoided. Furthermore, by notifying the source cell that no suitable target could be found, the source cell (e.g., the network entity providing the source cell) can respond appropriately so that the UE does not lose service.

Aspects of the present disclosure are described in the context of a wireless communications system. Aspects of the present disclosure are further illustrated and described with reference to device diagrams and flowcharts.

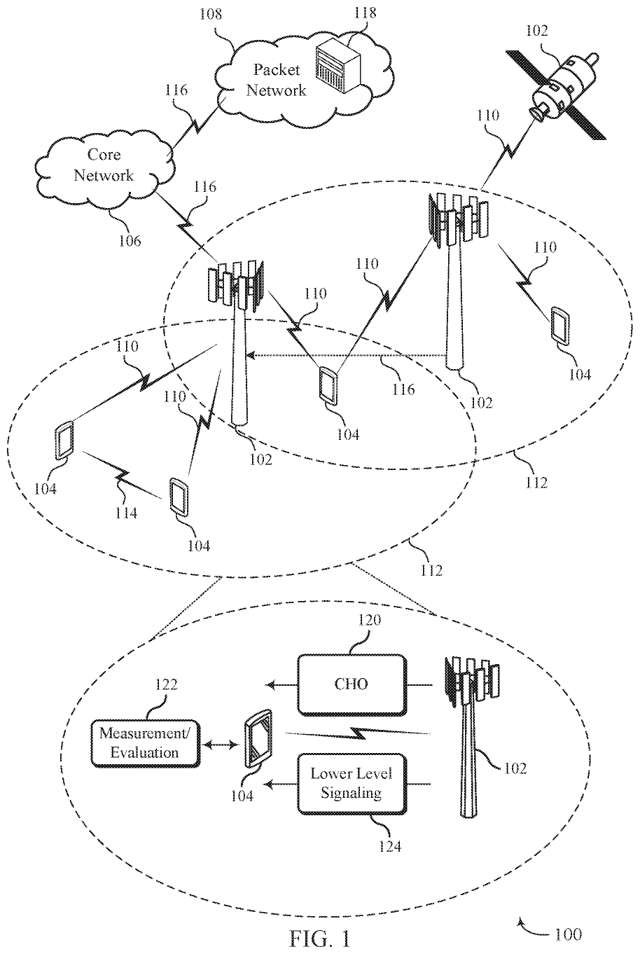

FIG. 1 illustrates an example of a wireless communications system 100 that supports timer based handover in a network energy saving cell in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1.

Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), a user plane function (UPF)), or a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. The first numerology (e.g., p=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix. A sixth numerology (e.g., u=5) may be associated with a sixth subcarrier spacing (e.g., 480 kHz) and a normal cyclic prefix. A seventh numerology (e.g., u=6) may be associated with a sixth subcarrier spacing (e.g., 960 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., u=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., p=0), which includes 15 kHz subcarrier spacing; a second numerology (e.g., u=1), which includes 30 kHz subcarrier spacing; and a third numerology (e.g., u=2), which includes 60 kHz subcarrier spacing. FR2 may be associated with one or multiple numerologies (e.g., at least 2 numerologies). For example, FR2 may be associated with a third numerology (e.g., u=2), which includes 60 kHz subcarrier spacing; and a fourth numerology (e.g., u=3), which includes 120 kHz subcarrier spacing.

A network entity 102 provides a serving cell that serves a UE entity 104. The network entity 102 sends a CHO 120 to the UE 104 that indicates a conditional handover configuration that includes one or more handover conditions. In response to the CHO 120, the UE 104 starts a measurement or evaluation process 122 to identify a candidate cell that satisfies the one or more handover conditions. In response to identifying a candidate cell that satisfies the one or more handover conditions, the UE 104 starts a timer. The UE 104 also receives a lower level signaling 124 (e.g., layer 1 signaling). This lower level signaling 124 indicates, for example, start of the cell discontinuous transmission (DTX) or DRX for the cell provided by the network entity 102, indicates a start of a sleep time for a corresponding cell DTX or DRX for the cell provided by the network entity 102, and so forth. If the lower level signaling 124 is received before expiry of the timer, handover to the candidate cell is executed. If the timer expires but the handover is not executed, the UE 104 resumes measuring and evaluating handover conditions for candidate cells rather than executing the handover.

Emissions and energy consumption from different elements of a telecommunication system is adversely contributing to the climate. Besides, the operating expenses to run a telecommunication services are huge. In telecoms, a number of industry-specific factors rooted in countering rising network costs have further shaped efficiency efforts. Combined with the rising costs of spectrum, capital investment and ongoing RAN maintenance/upgrades, energy-saving measures in network operations may be viewed as necessary rather than nice to have. 5G New Radio (NR) offers a significant energy-efficiency improvement per gigabyte over previous generations of mobility. However, new 5G use cases and the adoption of mm Wave will require more sites and antennas. This leads to the prospect of a more efficient network that could paradoxically result in higher emissions without active intervention.

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g., extended reality (XR)), networks are being denser, use more antennas, larger bandwidths, and more frequency bands. It is desirable to keep the environmental impact of 5G under control, and novel solutions to improve network energy savings are to be developed.

Energy consumption has become a key part of the operators' operational expenditure (OPEX). For example, the energy cost on mobile networks may account for approximately 23% of the total operator cost. Most of the energy consumption comes from the radio access network and in particular from the active antenna unit (AAU), with data centers and fiber transport accounting for a smaller share. The power consumption of a radio access can be split into two parts: the dynamic part which is only consumed when data transmission or reception is ongoing, and the static part which is consumed all the time to maintain the necessary operation of the radio access devices, even when the data transmission or reception is not on-going.

Therefore, it is desirable to develop a network energy consumption model especially for the base station, key performance indicators (KPIs), an evaluation methodology and to identify and study network energy savings techniques in targeted deployment scenarios. This should include investigating how to achieve more efficient operation dynamically and/or semi-statically and finer granularity adaptation of transmissions and/or receptions in one or more of network energy saving techniques in time, frequency, spatial, and power domains, with potential support/feedback from UE, potential UE assistance information, and information exchange/coordination over network interfaces.

The potential network energy consumption gains are not only evaluated, but also the impact on network and user performance is also assessed and balanced, e.g., by looking at KPIs such as spectral efficiency, capacity, user perceived throughput (UPT), latency, UE power consumption, complexity, handover performance, call drop rate, initial access performance, service level agreement (SLA) assurance related KPIs, etc.

One of the techniques to improve network energy savings are techniques in time domain, e.g., cell DTX or DRX.

Cell DTX or DRX is applied to at least UEs in RRC_CONNECTED state. A periodic cell DTX or DRX (e.g., active, and non-active periods) can be configured by the network entity (e.g., gNB) via UE-specific RRC signaling per serving cell. Below examples on cell DTX or DRX behavior during non-active periods are assumed to be possible options:
Example 1: the network entity (e.g., gNB) is expected to turn off all transmission and reception for data traffic and reference signal during cell DTX or DRX non-active periods.
Example 2: the network entity (e.g., gNB) is expected to turn off its transmission or reception only for data traffic during cell DTX or DRX non-active periods (e.g., the network entity (e.g., gNB) will still transmit or receive reference signals)
Example 3: the network entity (e.g., gNB) is expected to turn off its dynamic data transmission/reception during Cell DTX or DRX non-active periods (e.g., the network entity (e.g., gNB) is expected to still perform transmission or reception in periodic resources, including semi-persistent scheduling (SPS), configured grant-physical uplink shared channel (CG-PUSCH), SR, RACH, and sounding reference signal (SRS)).
Example 4: the network entity (e.g., gNB) is expected to only transmit reference signals (e.g., channel state information reference signal (CSI-RS) for measurement).

UE behavior when at any point in time the cell activates a single DTX/DRX configuration is studied. It is up to the network whether legacy UEs can access cells with cell DTX or DRX.

The cell DTX or DRX mode can be activated or de-activated via dynamic L1/L2 signaling and UE-specific RRC signaling. Both UE specific and common L1/L2 signaling can be considered for activating or deactivating the cell DTX or DRX mode.

Cell DTX and cell DRX modes can be configured and operated separately (e.g., one RRC configuration set for downlink (DL) and another for uplink (UL)). Cell DTX or DRX can also be configured and operated together. At least the following parameters can be configured per Cell DTX or DRX configuration: periodicity, start slot or offset, on duration. Details related to UE behavior can be discussed and whether to support multiple cell DTX or DRX configurations can be discussed.

It may be determined that it is beneficial to align cell DTX and DRX among multiple UEs.

With the introduction of cell DTX and DRX, a question also arises as to how this will impact the connected mode mobility. Two main mechanisms include: first, using explicit handover command (e.g., RRCReconfiguration message containing reconfiguration WithSync) from the network to the UE, which in turn upon receiving the handover command immediately starts to execute handover e.g., synchronizes with target cell included in the handover command and initiates RACH procedure to announce successful handover completion on the target side. Second, using a conditional handover configuration (e.g., RRCReconfiguration message containing conditionalReconfiguration, also called “CHO” herein) from the network to the UE, which in turn upon receiving the conditional handover configuration does not immediately execute handover but first monitors certain conditions configured in the conditional Reconfiguration, which could be radio quality based (like measurement events A3, A4, A5 etc. defined in 3rd generation partnership project (3GPP) technical specification (TS) 38.331), or time or location based (for example event T1 defined for Non-Terrestrial Communication in 3GPP TS 38.331). The handover execution is only started upon fulfillment of one (or more) conditions configured for a corresponding candidate (target) cell included in the conditional handover configuration. When the source cell intends to use a network energy saving (NES) technique, it may use a bit more relaxed handover condition to ensure that a UE has a higher probability of finding a target cell (e.g., a candidate cell that has fulfilled included conditions)—this cane be in form of a lower radio threshold for qualifying as a suitable target cell. This may lead the UE to be in a non-optimum radio cell, at least temporarily until it moves further to the cell center of the target cell or finds a better (radio) target cell.

Using the second mechanism, a source cell sends CHO to the UE but starts an NES technique only some time later allowing the UEs in the cell sufficient time to evaluate handover conditions contained in the CHO. Due to this, there might a time gap between the fulfillment of handover conditions towards a candidate cell leading to handover execution and the time when the source cell start the NES technique, e.g., starts to sleep (transitions to non-active time). A too early handover execution will lead UE breaking or releasing connection from an otherwise very strong source cell and going to relaxed-radio-conditioned target cell. On the other hand, a too late handover execution may mean that the conditions once considered fulfilled may not be valid anymore. Both situations lead to a bad user experience.

The techniques discussed herein describe UE and network methods enabling network energy saving without (or only very little (e.g., minimally)) adversely affecting user experience if and when a handover procedure is required.

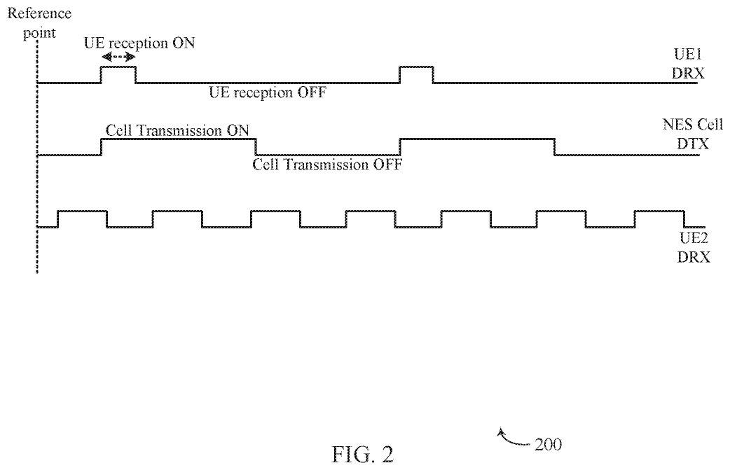

FIG. 2 illustrates an example 200 of two RRC Connected UEs with their corresponding DRX configurations that supports timer based handover in a network energy saving cell in accordance with aspects of the present disclosure. The example 200 shows two RRC Connected UEs with their corresponding DRX configurations, as well as their serving cell in energy saving mode utilizing a DTX configuration. A UE configured with DRX can transmit any time, but when the cell is in DTX the UE may not receive any response back from the network. For example, a UE configured with a DRX configuration can transmit at any time, but it can receive only during certain limited time periods designated as “active time” and shown in the example 200 as “UE reception ON” period. In downlink, the cell is not expected to transmit during “Cell Transmission OFF” periods, referred to as “non-active period” in the previously mentioned examples. To which signals or channels the transmission-off is applied can vary from scenario to scenario and is simply a network implementation. Previous examples on Cell DTX or DRX behavior can be applied by a network vendor and while one vendor may use only one example scenario when saving cell energy, other vendors may reconfigure from one example to another from time to time depending on the current load and other factors. It is therefore up to the network implementation if a network entity (e.g., gNB) is expected to turn off all transmission or reception for data traffic, or turn off all reference signal during Cell DTX or DRX non-active periods—but in any case, the network entity (e.g., gNB) informs UEs being served in the corresponding cell about the current energy saving configuration being (or to be) used in the cell.

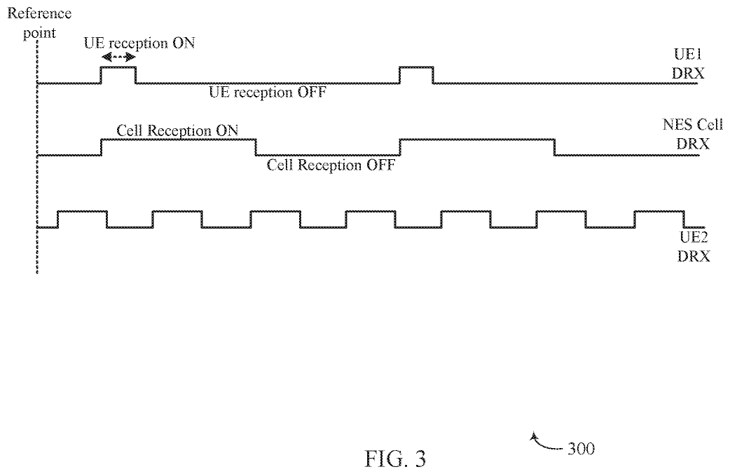

FIG. 3 illustrates an example 300 of two RRC Connected UEs with their corresponding DRX configurations that supports timer based handover in a network energy saving cell in accordance with aspects of the present disclosure. The example 300 shows two RRC Connected UEs with their corresponding DRX configurations, as well as their serving cell in energy saving mode utilizing a DRX configuration. A UE configured with DRX can transmit any time, but when the cell is in DRX the UE transmissions will not be received. For example, a UE configured with a DRX configuration can transmit at any time, but it can receive only during certain limited time periods designated as “active time” and shown in the example 300 as “UE reception ON” period. In uplink, the cell is not expected to receive during “Cell Reception OFF” periods, referred as “non-active period”.

In the following the term cell DRX (or network DRX) is used to designate the non-reception generally, the DRX may mean a blanket absence of reception of any or all UL transmissions; and the term cell DTX (or network DTX) is used to designate the non-transmission generally without regard to a particular example cited previously, the DTX may mean a blanket stop to all DL transmissions or only to specific DL transmissions such as data, control or reference signals, as the case may be.

Apart from the above-mentioned cell DRX and cell DTX technique, another technique may be used where the cell switches off its transmission and reception simultaneously. The cell can switch on again after a while and then start to serve any UEs camped in the cell regularly.

In one or more implementations, the serving cell first determines if the quality of service (QoS) of one or more bearers of an RRC Connected UE will be adversely impacted (e.g., QoS of the bearer will be degraded beyond an acceptable level) if the cell starts using NES mode. Using NES mode here refers to that cell activating or starting using one of the NES technologies including but not limited to: one or both of cell DTX or cell DRX; cell switch off; power domain techniques to contain physical downlink shared channel (PDSCH) transmission power; or spatial domain techniques to reduce transmission power by keeping same CSI-RS ports but muting a subset of antenna elements within antenna ports, or activation of a subset of CSI-RS ports (measure CSI with respect to a subset of the ports of a given CSI-RS resource).

After having determined positively that at least one bearer of a UE will be impacted, the serving cell determines neighboring cells that may be used as candidates for handover of this UE. Towards this end, the serving cell (also referred to as source cell) will initiate handover preparation towards one or more candidate cells. As a result of the handover preparation, a CHO can be sent to the UE. Depending on the employed NES technique, the source cell may also send the cell's NES mode specific information, e.g., cell DTX or DRX configuration to the UE, which can be done using RRC signaling (as opposed to lower layer signaling) for higher reliability purposes. The cell DTX or DRX configuration includes a start offset (an offset from system frame number (SFN) #0, slot or subframe #0 defining when the active or sleep time of the cell first starts), periodicity (how often the DRX or DTX cycle repeats), and on duration length (at least how long is the network active in each DRX or DTX cycle).

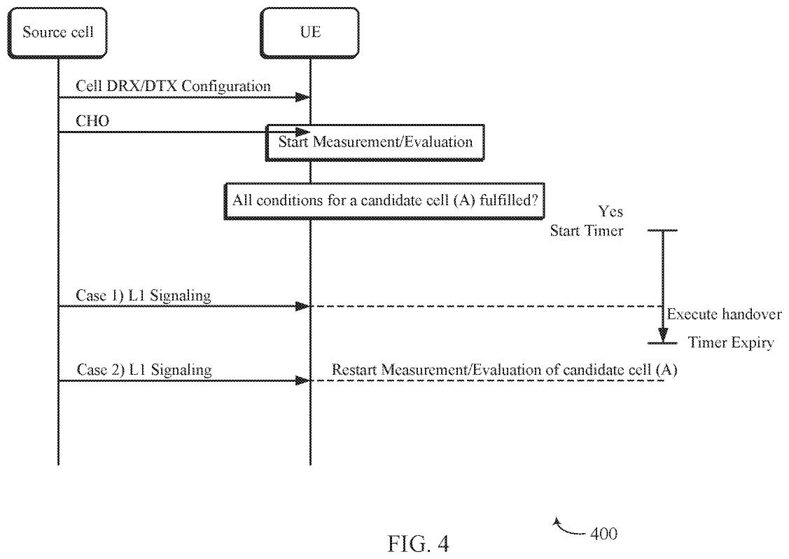

FIG. 4 illustrates an example 400 of handover being executed that supports timer based handover in a network energy saving cell in accordance with aspects of the present disclosure. In the example 400, handover is executed only after a trigger after the CHO conditions are fulfilled. L1 signaling illustrated as an example of a “trigger” in the example 400, and it is to be appreciated that other triggers can be used. After receiving the CHO the UE starts measurements of the candidates included in the CHO and evaluates the one or more conditions contained in the CHO. Once at least one candidate is found for which all of the one or more conditions included in the CHO are considered fulfilled, the UE starts a timer. The value of the timer is network configured and can be provided by the source cell in CHO or in the RRC signaling providing the cell DTX or DRX configuration or could be advertised in one of the broadcasted SIBs. If the NES mode of the source cell is triggered before the expiry of this timer, the UE starts handover execution towards the cell for which the timer is running.

In one or more implementations, the UE considers that NES mode of the source cell is triggered when the source cell sends a L1 signaling indicating start of the cell DTX or DRX. The NES mode of the source cell is considered triggered at the time of reception of the LI signaling or at the end of a time offset included in the L1 signaling. The time offset could be of absolute value, e.g., in milliseconds, in the form of a future SFN and slots or subframe number, or in slots or subframe offset for the sub-carrier spacing (SCS) in use and is applied from the point of receiving the L1 command.

Additionally or alternatively, the UE considers that NES mode of the source cell is triggered when the source cell sends a L1 signaling indicating start of the sleep time for a corresponding cell DTX or DRX. The NES mode of the source cell is considered triggered at the time of reception of the L1 signaling or at the end of a time offset included in the L1 signaling. The time offset could be of absolute value, e.g., in milliseconds., in the form of a future SFN and slots or subframe number, or in slots or subframe offset for the SCS in use and is applied from the point of receiving the L1 command.

Additionally or alternatively, the UE considers that NES mode of the source cell is triggered when the source cell sends a L1 signaling indicating start of the sleep time (for the case where the NES technique uses cell switch off). The NES mode of the source cell is considered triggered at the time of reception of the L1 signaling or at the end of a time offset included in the L1 signaling. The time offset could be of absolute value, e.g., in milliseconds, in the form of a future SFN and slots or subframe number, or in slots or subframe offset for the SCS in use and is applied from the point of receiving the L1 command.

Additionally or alternatively, the UE considers that NES mode of the source cell is triggered when the cell is entering sleep time, which the UE determines itself based on the received start offset cell DTX or DRX.

As one enhancement, instead of the timer started only for the first candidate cell fulfilling all of its corresponding one or more conditions, one instance of the timer per candidate cell (for which all corresponding one or more conditions included in the CHO are considered fulfilled) is used or started. If there is more than one cell for which a timer instance is running, the UE may choose to execute handover towards the candidate cell for which the timer was started most recently, e.g., the candidate cell (which now becomes a target cell) which has most recently fulfilled the handover conditions. This ensures that the measurements and therefore the radio conditions towards this cell are still most relevant. Additionally or alternatively, in this situation the UE chooses to execute handover towards a candidate cell that has the best reference signal received power (RSRP) or reference signal received quality (RSRQ) value among all the candidate cells fulfilling their corresponding one or more conditions included in the CHO.

If the timer for a corresponding candidate expires but the handover is not executed, the UE may start one or both of measurement or measurement evaluation for the candidate immediately, as illustrated in the example 400.

As a further enhancement, an instance of the timer may be started per condition per candidate cell. To illustrate further, if there are 2 conditions for 3 candidate cells included in the CHO, a total of 6 timer instances might be running.

In one or more implementations, the UE starts measurement and measurement evaluation of the candidates included in CHO only when one of the following occurs: the UE receives a L1 signaling from the source cell indicating start of the cell DTX or DRX cycle; the UE receives a L1 signaling from the source cell indicating start of the sleep time for a corresponding cell DTX or DRX cycle; the UE receives a L1 signaling from the source cell indicating start of the sleep time (for the case where NES technique uses cell switch off); or a time (T1) before the start offset configured for cell DTX or DRX, as received in RRC signaling. The value of the time T1 is network configured and can be provided by the source cell in CHO or in the RRC signaling providing the cell DTX or DRX configuration or could be advertised in one of the broadcasted SIBs.

In one or more implementations, the UE starts measurement immediately after receiving CHO, but measurement evaluation of the candidates included in CHO start only when one of the following occurs: the UE receives a L1 signaling from the source cell indicating start of the cell DTX or DRX cycle; the UE receives a L1 signaling from the source cell indicating start of the sleep time for a corresponding cell DTX or DRX cycle; the UE receives a L1 signaling from the source cell indicating start of the sleep time (for the case where NES technique uses cell switch off); or a time (T1) before the start offset configured for cell DTX or DRX, as received in RRC signaling. The value of the time T1 is network configured and can be provided by the source cell in CHO or in the RRC signaling providing the cell DTX or DRX configuration or could be advertised in one of the broadcasted SIBs.

Accordingly, an indication of time of switch off using L1 signaling is discussed herein. No prior RRC signaling is required in this case.

A mechanism enabling determination of how long a measurement or evaluation leading to fulfillment of one or all of one or more handover conditions is discussed herein. A corresponding timer for this purpose can be configured by the network.

A mechanism delaying one or both of measurement or measurement evaluation until a further trigger is discussed herein. The trigger may be one of the following: reception of a further L1 signaling from the source cell; end of a time offset included in a L1 signaling received from the source cell; a UE determined start offset from the received cell DRX or DTX configuration; or a time (T1) before the start offset configured for cell DTX or DRX, as received in RRC signaling.

FIG. 5 illustrates an example of a block diagram 500 of a device 502 that supports timer based handover in a network energy saving cell in accordance with aspects of the present disclosure. The device 502 may be an example of a UE 104 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. Processor 504 may be configured as or otherwise support to: receive, from a network entity, a first signaling indicating a conditional handover configuration that includes one or more handover conditions; start a timer in response to determining that one or more handover conditions for a candidate cell indicated in the first signaling are fulfilled; and execute handover to the candidate cell in response to receiving a lower layer signaling from the network before expiry of the timer.

Additionally or alternatively, the processor 504 may be configured to or otherwise support: where the first signaling comprises a RRC Connection Reconfiguration message; where the first signaling indicates a timer value for the timer; where the processor is configured to cause the apparatus to restart measuring and evaluating handover conditions for the candidate cell upon expiry of the timer; where the RRC Connection Reconfiguration message includes RRC Reconfiguration for one or more candidate cells; where the one or more handover conditions include measurement events and may be based on at least one of radio condition evaluation, time condition evaluation, or location condition evaluation; where the candidate cell becomes a target cell in response to determining that the one or more handover conditions for the candidate cell are fulfilled; where to execute handover to the candidate cell includes tuning to a frequency of the candidate cell, synchronizing to a downlink channel of the candidate cell, and initiating a RACH procedure to announce arrival of the apparatus at the candidate cell; where the apparatus comprises a UE.

For example, the processor 504 may support wireless communication at the device 502 in accordance with examples as disclosed herein. Processor 504 may be configured as or otherwise support a means for: receiving, from a network entity, a first signaling indicating a conditional handover configuration that includes one or more handover conditions; starting a timer in response to determining that one or more handover conditions for a candidate cell indicated in the first signaling are fulfilled; and executing handover to the candidate cell in response to receiving a lower layer signaling from the network before expiry of the timer.

Additionally or alternatively, the processor 504 may be configured to or otherwise support: where the first signaling comprises a RRC Connection Reconfiguration message; where the first signaling indicates a timer value for the timer; restarting measuring and evaluating handover conditions for the candidate cell upon expiry of the timer; where the RRC Connection Reconfiguration message includes RRC Reconfiguration for one or more candidate cells; where the one or more handover conditions include measurement events and may be based on at least one of radio condition evaluation, time condition evaluation, or location condition evaluation; where the candidate cell becomes a target cell in response to determining that the one or more handover conditions for the candidate cell are fulfilled; where executing handover to the candidate cell includes tuning to a frequency of the candidate cell, synchronizing to a downlink channel of the candidate cell, and initiating a RACH procedure to announce arrival of an apparatus implementing the method at the candidate cell; where the method is implemented by a UE.

The processor 504 of the device 502, such as a UE 104, may support wireless communication in accordance with examples as disclosed herein. The processor 504 includes at least one controller coupled with at least one memory, and is configured to or operable to cause the processor to receive, from a network entity, a first signaling indicating a conditional handover configuration that includes one or more handover conditions; start a timer in response to determining that one or more handover conditions for a candidate cell indicated in the first signaling are fulfilled; and execute handover to the candidate cell in response to receiving a lower layer signaling from the network before expiry of the timer.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device 502. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

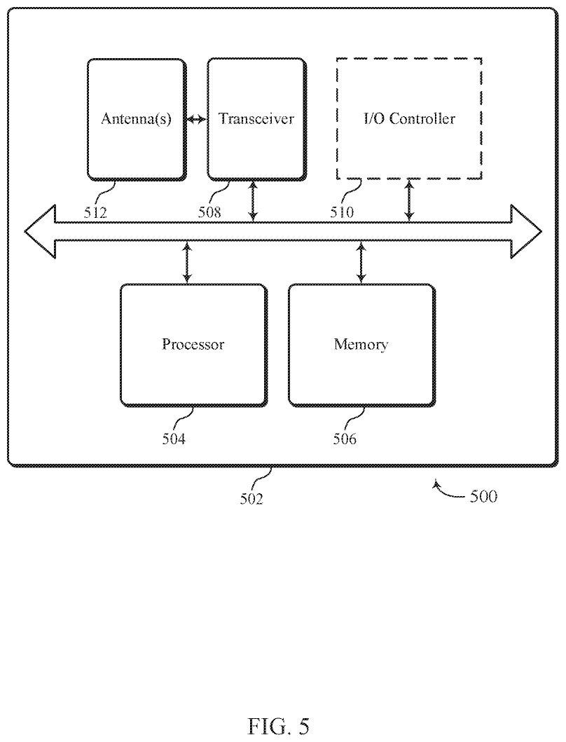

FIG. 6 illustrates an example of a block diagram 600 of a device 602 that supports timer based handover in a network energy saving cell in accordance with aspects of the present disclosure. The device 602 may be an example of a network entity 102 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. Processor 604 may be configured as or otherwise support to: transmit, to a UE, a first signaling indicating a conditional handover configuration that includes one or more handover conditions including a timer value for a timer, the timer value indicating an amount of time the UE is to wait to receive a lower layer signaling for a candidate cell for which the one or more handover conditions are fulfilled; and transmit, to the UE, the lower layer signaling.

Additionally or alternatively, the processor 604 may be configured to or otherwise support: where the lower layer signaling indicates a start of sleep time of a cell served by the apparatus; where the first signaling comprises a RRC Connection Reconfiguration message; where the RRC Connection Reconfiguration message includes RRC Reconfiguration for one or more candidate cells; where the one or more handover conditions include measurement events and may be based on at least one of radio condition evaluation, time condition evaluation, or location condition evaluation.

For example, the processor 604 may support wireless communication at the device 602 in accordance with examples as disclosed herein. Processor 604 may be configured as or otherwise support a means for transmitting, to a UE, a first signaling indicating a conditional handover configuration that includes one or more handover conditions including a timer value for a timer, the timer value indicating an amount of time the UE is to wait to receive a lower layer signaling for a candidate cell for which the one or more handover conditions are fulfilled; and transmitting, to the UE, the lower layer signaling.

Additionally or alternatively, the processor 604 may be configured to or otherwise support: where the lower layer signaling indicates a start of sleep time of a cell served by an apparatus implementing the method; where the first signaling comprises a RRC Connection Reconfiguration message; where the RRC Connection Reconfiguration message includes RRC Reconfiguration for one or more candidate cells; where the one or more handover conditions include measurement events and may be based on at least one of radio condition evaluation, time condition evaluation, or location condition evaluation.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device 602. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

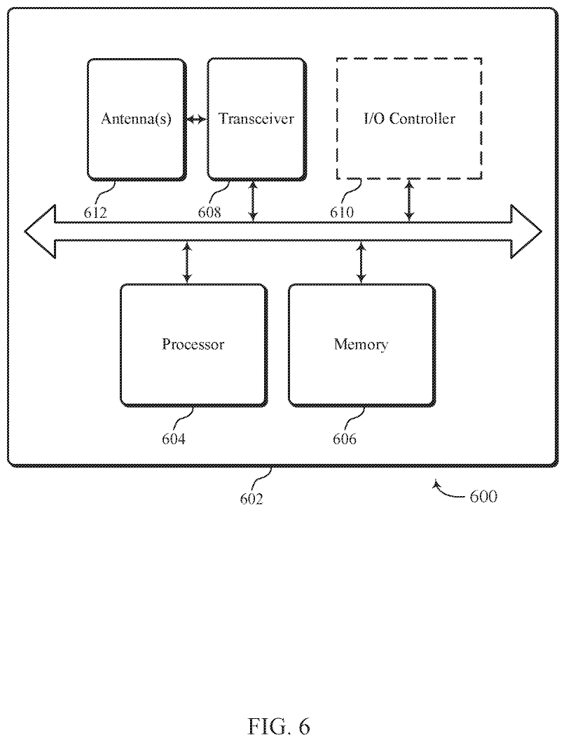

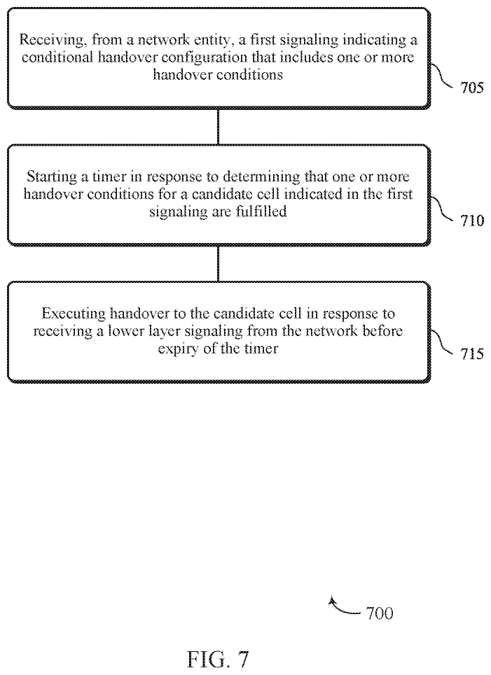

FIG. 7 illustrates a flowchart of a method 700 that supports timer based handover in a network energy saving cell in accordance with aspects of the present disclosure. The operations of the method 700 may be implemented by a device or its components as described herein. For example, the operations of the method 700 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 705, the method may include receiving, from a network entity, a first signaling indicating a conditional handover configuration that includes one or more handover conditions. The operations of 705 may be performed in accordance with examples as described herein. In some implementations, aspects of the operations of 705 may be performed by a device as described with reference to FIG. 1.

At 710, the method may include starting a timer in response to determining that one or more handover conditions for a candidate cell indicated in the first signaling are fulfilled. The operations of 710 may be performed in accordance with examples as described herein. In some implementations, aspects of the operations of 710 may be performed by a device as described with reference to FIG. 1.

At 715, the method may include executing handover to the candidate cell in response to receiving a lower layer signaling from the network before expiry of the timer. The operations of 715 may be performed in accordance with examples as described herein. In some implementations, aspects of the operations of 715 may be performed by a device as described with reference to FIG. 1.

FIG. 8 illustrates a flowchart of a method 800 that supports timer based handover in a network energy saving cell in accordance with aspects of the present disclosure. The operations of the method 800 may be implemented by a device or its components as described herein. For example, the operations of the method 800 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 805, the method may include wherein the first signaling comprises a RRC Connection Reconfiguration message. The operations of 805 may be performed in accordance with examples as described herein. In some implementations, aspects of the operations of 805 may be performed by a device as described with reference to FIG. 1.

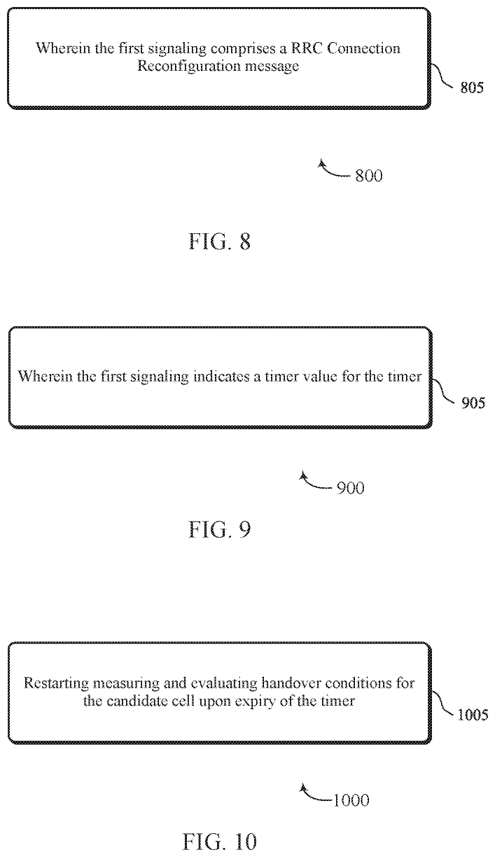

FIG. 9 illustrates a flowchart of a method 900 that supports timer based handover in a network energy saving cell in accordance with aspects of the present disclosure. The operations of the method 900 may be implemented by a device or its components as described herein. For example, the operations of the method 900 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 905, the method may include wherein the first signaling indicates a timer value for the timer. The operations of 905 may be performed in accordance with examples as described herein. In some implementations, aspects of the operations of 905 may be performed by a device as described with reference to FIG. 1.

FIG. 10 illustrates a flowchart of a method 1000 that supports timer based handover in a network energy saving cell in accordance with aspects of the present disclosure. The operations of the method 1000 may be implemented by a device or its components as described herein. For example, the operations of the method 1000 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1005, the method may include restarting measuring and evaluating handover conditions for the candidate cell upon expiry of the timer. The operations of 1005 may be performed in accordance with examples as described herein. In some implementations, aspects of the operations of 1005 may be performed by a device as described with reference to FIG. 1.

FIG. 11 illustrates a flowchart of a method 1100 that supports timer based handover in a network energy saving cell in accordance with aspects of the present disclosure. The operations of the method 1100 may be implemented by a device or its components as described herein. For example, the operations of the method 1100 may be performed by a network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1105, the method may include transmitting, to a UE, a first signaling indicating a conditional handover configuration that includes one or more handover conditions including a timer value for a timer, the timer value indicating an amount of time the UE is to wait to receive a lower layer signaling for a candidate cell for which the one or more handover conditions are fulfilled. The operations of 1105 may be performed in accordance with examples as described herein. In some implementations, aspects of the operations of 1105 may be performed by a device as described with reference to FIG. 1.

At 1110, the method may include transmitting, to the UE, the lower layer signaling. The operations of 1110 may be performed in accordance with examples as described herein. In some implementations, aspects of the operations of 1110 may be performed by a device as described with reference to FIG. 1.

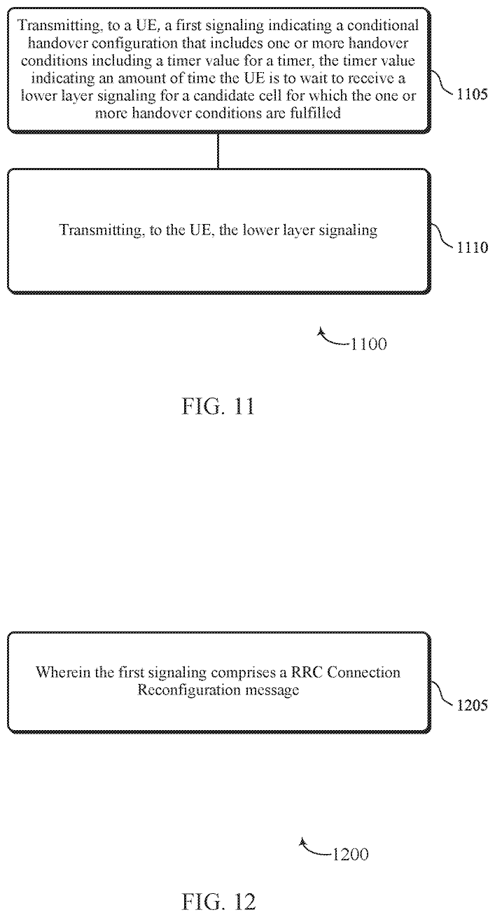

FIG. 12 illustrates a flowchart of a method 1200 that supports timer based handover in a network energy saving cell in accordance with aspects of the present disclosure. The operations of the method 1200 may be implemented by a device or its components as described herein. For example, the operations of the method 1200 may be performed by a network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1205, the method may include wherein the first signaling comprises a RRC Connection Reconfiguration message. The operations of 1205 may be performed in accordance with examples as described herein. In some implementations, aspects of the operations of 1205 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of one or both of A or B means A or B or AB. Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a conditional handover configuration that includes one or more handover conditions;
start a timer in response to determining that one or more handover conditions for a candidate cell indicated in the conditional handover configuration are fulfilled; and
execute handover to the candidate cell in response to receiving a lower layer signaling from a network before expiry of the timer.

2. The UE of claim 1, wherein the conditional handover configuration comprises a radio resource control (RRC) Connection Reconfiguration message.

3. The UE of claim 1, wherein the conditional handover configuration indicates a timer value for the timer.

4. The UE of claim 1, wherein the at least one processor is further operable to cause the UE to restart measuring and evaluating handover conditions for the candidate cell upon expiry of the timer.

5. The UE of claim 2, wherein the RRC Connection Reconfiguration message includes RRC Reconfiguration for one or more candidate cells.

6. The UE of claim 1, wherein the one or more handover conditions include measurement events and may be based on at least one of radio condition evaluation, time condition evaluation, or location condition evaluation.

7. The UE of claim 1, wherein the candidate cell becomes a target cell in response to determining that the one or more handover conditions for the candidate cell are fulfilled.

8. The UE of claim 1, wherein to execute handover to the candidate cell the at least one processor is configured to tune to a frequency of the candidate cell, synchronize to a downlink channel of the candidate cell, and initiate a random access channel (RACH) procedure to announce arrival of the UE at the candidate cell.

9. A base station for wireless communication, comprising:
at least one memory; and
at least one processor coupled with the at least one memory and operable to cause the base station to:
transmit a conditional handover configuration that includes one or more handover conditions including a timer value for a timer, the timer value indicating an amount of time a user equipment (UE) is to wait to receive a lower layer signaling for a candidate cell for which the one or more handover conditions are fulfilled; and
transmit the lower layer signaling.

10. The base station of claim 9, wherein the lower layer signaling indicates a start of sleep time of a cell served by the base station.

11. A method performed by a user equipment (UE), the method, comprising:
receiving a conditional handover configuration that includes one or more handover conditions;
starting a timer in response to determining that one or more handover conditions for a candidate cell indicated in the conditional handover configuration are fulfilled; and
executing handover to the candidate cell in response to receiving a lower layer signaling from a network before expiry of the timer.

12. The method of claim 11, wherein the conditional handover configuration is a radio resource control (RRC) Connection Reconfiguration message.

13. The method of claim 11, further comprising restarting measuring and evaluating handover conditions for the candidate cell upon expiry of the timer.

14-20. (canceled)

21. The base station of claim 9, wherein the conditional handover configuration comprises a radio resource control (RRC) Connection Reconfiguration message.

22. The base station of claim 21, wherein the RRC Connection Reconfiguration message includes RRC Reconfiguration for one or more candidate cells.

23. The base station of claim 9, wherein the one or more handover conditions include measurement events that are based on at least one of radio condition evaluation, time condition evaluation, or location condition evaluation.

24. A method, comprising:
transmitting a conditional handover configuration that includes one or more handover conditions including a timer value for a timer, the timer value indicating an amount of time a user equipment (UE) is to wait to receive a lower layer signaling for a candidate cell for which the one or more handover conditions are fulfilled; and
transmitting the lower layer signaling.

25. The method of claim 24, wherein the lower layer signaling indicates a start of sleep time of a cell served by an apparatus implementing the method.

26. The method of claim 24, wherein the conditional handover configuration comprises a radio resource control (RRC) Connection Reconfiguration message.

27. The method of claim 26, wherein the RRC Connection Reconfiguration message includes RRC Reconfiguration for one or more candidate cells.
